(19) United States
(12) Patent Application Publication
(10) Pub. No.: US 2004/0115384 A1
(43) Pub. Date: Jun. 17, 2004

(54) Static cling toy and method of making

(76) Inventor: Michael P. Scharber, Waukesha, WI (US)

Correspondence Address: QUARLES & BRADY LLP, 411 E. WISCONSIN AVENUE, SUITE 2040, MILWAUKEE, WI, 53202-4497, US

(21) Appl. No.: 10/320,255

(22) Filed: Dec. 16, 2002

(51) Int. Cl. B32B 9/00; B32B 31/00

(52) U.S. Cl. 428/40.1; 428/79; 156/267; 156/289; 156/306.3

(57) ABSTRACT

A static cling toy assembly which can be inserted into a food item and method of making includes a static cling substrate having a first side and a second side. At least one cut out adheres to the first side of the substrate by means of static cling. A peelable protector sheet is releasably fixed over the at least one cut out, wherein the protector sheet encapsulates the at least one cut out and protects it from contamination.

### CROSS REFERENCES TO RELATED APPLICATIONS

Not Applicable

### STATEMENT REGARDING FEDERALLY SPONSORED RESEARCH

Not Applicable

### BACKGROUND OF THE INVENTION

The invention relates generally to static cling toys, and more particularly to static cling toys which can be placed in packages containing food products.

In the marketing of a variety of food products, such as potato chips, bakery goods, cereals, and the like, promotional items, such as coupons, recipes, collection cards, or other types of printed promotions are often inserted into the packaging to induce a consumer to purchase the particular food product. These promotional items typically comprise printed matter having images printed thereon using printing ink. Numerous problems are presented when food oils contact the printing ink. The Food and Drug Administration allows only a small number of water or vegetable-based inks to be used in materials that are in direct contact with food. This limits the amount of applications for promotional programs. The food product must be protected from ink or odor contamination coming from the promotional coupon or card.

Food oils also preclude inserting promotional games, decorations, or toys into food items that can be fouled or rendered inoperative upon contacting the food items. Promotional toys, decorations, or games, such as disclosed in U.S. Pat. Nos. 4,652,239 and 5,162,138 which are fully incorporated herein by reference, that include a character cutout that statically clings to a substrate are particularly troublesome because the food oils foul the substrate or cutout which prevents the cutout from adhering to the substrate rendering the toy inoperative.

One solution for isolating inks from food oils is disclosed in U.S. Pat. No. 4,837,956 issued to Dolence. In Dolence, a message-carrying food insert is disclosed comprising a laminated central core layer. The lamination permanently seals the ink forming the message printed on the core layer from the food. This particular solution, however, does not provide for toys or games incorporating parts that are removable from a primary substrate or core layer.

Another solution well known in the art for isolating inks in a food insert from the food is to over wrap the insert which seals the insert in a plastic enclosure. In order to gain access to the insert, the plastic enclosure is ripped open, and the insert is removed. Over wrapping, however, is costly, and is not easily inserted into food items using automation.

### SUMMARY OF THE INVENTION

The present invention provides a static cling toy assembly which can be inserted into a food item and a method of making. The static cling toy assembly includes a static cling substrate having a first side and a second side. At least one cut out adheres to the first side of the substrate by means of static cling. A peelable protector sheet is releasably fixed over the at least one cut out, wherein the protector sheet encapsulates the at least one cut out and protects it from contamination.

A general objective of the present invention is to provide a static cling toy than can inserted into a food item. This objective is accomplished by providing a static cling toy assembly having at least one cut out adhering to a static cling substrate by means of static cling, and protecting the at least one cut out from contamination by a peelable protector sheet that covers the at least one cut out.

Another objective of the present invention is to provide a static cling toy including an interactive scene for use with the at least one cut out thereto by means of static cling. This objective is accomplished by providing a static cling toy assembly having a scene formed on a substrate forming part of the static cling toy assembly and covering the scene with a protector sheet on which the at least one cut out can adhere by means of static cling.

The foregoing and other objects and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is a perspective exploded view of a static cling toy assembly incorporating the present invention;

FIG. 2 is top view of the static cling toy assembly of FIG. 1;

FIG. 3 is a bottom view of the static cling toy of FIG. 1;

FIG. 4 is a cross sectional view along line 4-4 of FIG. 2;

FIG. 5 is a schematic representation of a manufacturing line for making the static cling toy assembly of FIG. 1; and

FIG. 6 is a perspective exploded view of another static cling toy assembly incorporating the present invention.

### DETAILED DESCRIPTION OF THE INVENTION

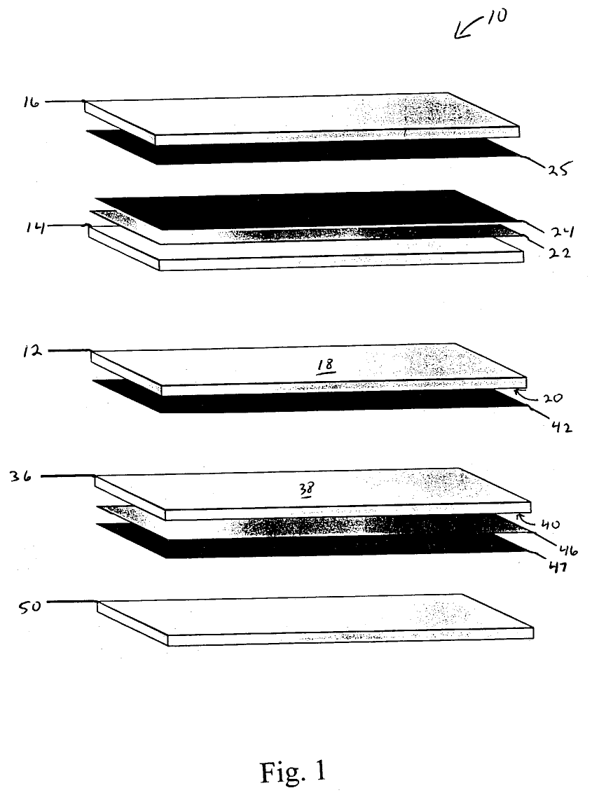

As shown in FIGS. 1-4, a static cling toy assembly 10 that can be inserted into food items includes a static cling base substrate 12, a plurality of cut outs 14 (shown as a sheet of material in FIG. 1) adhering to the static cling substrate 12 by means of static cling, and a peelable protector sheet 16 overlaying the cut outs 14. The protector sheet 16 encapsulates the cut outs 14 and protects them from contamination. Although a plurality of cut outs 14 is shown, one or more cut outs can be provided without departing from the scope of the invention.

The static cling substrate 12 is preferably formed from a clear oriented polyester having a first side 18 and a second side 20. The substrate 12 can be any thickness, however, preferably the substrate 12 is approximately 4 mils thick to provide flexibility. Although a polyester, such as available from Transilwrap Company, Inc. in Franklin Park, Ill., having static cling compatible properties, wherein a second material adheres to the static cling substrate 12 by means of static cling can be used without departing from the scope of the invention.

The cut outs 14 are preferably formed from a flexible clear or white vinyl, such as available from Transilwrap Company, Inc. in Franklin Park, Ill. Advantageously, the vinyl cut outs 14 adhere to the first side 18 of the polyester static cling substrate 12 by means of static cling. Although vinyl cut outs 14 are preferred, any material having static cling properties can be used without departing from the scope of the invention. The cut outs 14 can define any shape, such as cartoon characters, animals, vehicles, parts, people, food items, tools, letters of an alphabet, geometric shapes, and the like, without departing from the scope of the invention. Preferably, ink 22, such as a water based Pro Set and Versifilm ink available from Water Ink Technologies, Lincolnton, N.C., is applied to each cut out 14 to form an image on the cut out 14 and enhance the appeal of the cut out 14 to consumers.

The peelable protector sheet 16 is applied over the cut outs 14, and is releasably bonded to the first side 18 of the static cling substrate 12. Preferably, a release material 24, such as a UV low odor release varnish 19189A available from Northwest Coatings LLC, Oak Creek, Wis., is applied over the cut outs 14, and an adhesive, 25, such as a low coatweight acrylic adhesive available from ACPO Ltd., Oak Harbor, Ohio, bonds the protector sheet 16 to the first side 18 of the static cling substrate 12.

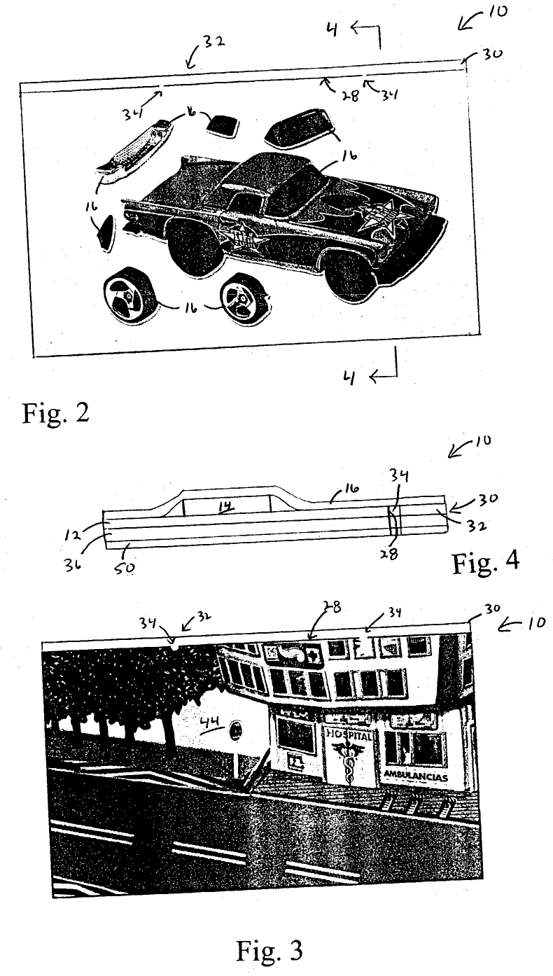

As shown in FIGS. 2 and 4, a portion of the peelable protector sheet 16 extends past a finished piece edge 28 of the static cling substrate 12 to form a pull tab 30. The pull tab 30 provides structure which is easily grasped by a user for easily peeling the peelable protector sheet 16 off of the cut outs 14. Although a pull tab 30 extending the length of the static cling substrate is shown, the pull tab can be formed at a corner of the assembly 10 or along the width of the assembly 10 without departing from the scope of the invention.

Preferably, the pull tab 30 includes a strip 32 of material cut from the static cling substrate 12 adjacent to the static cling substrate edge 28 and bonded to the peelable protector sheet 16. The strip 32 of material is joined to the static cling substrate edge 28 by one or more tack points 34 that are easily severed by the user as the protector sheet 16 is peeled off of the static cling substrate 12. Most preferably, the strip 32 of material is formed by cutting the static cling substrate 12 and any other materials fixed to the static cling substrate 12 prior to bonding the protector sheet 16 thereto.

In the embodiment disclosed in FIGS. 1-4, a base substrate 36 having first and second sides 38, 40 is bonded to the second side 20 of the static cling substrate 12, and forms a web on which the static cling toy assembly 10 is assembled. The base substrate 36 is formed from any suitable material, such as paper, plastic, fabric, and the like, that has sufficient strength for functioning as a web and can be bonded to the static cling substrate 12. In a food insertable embodiment, the base substrate 36 is preferably a polyethylene film that does not absorb food oils.

The base substrate 36 is bonded to the static cling substrate 12 using any methods known in the art, such as adhesives, thermal bonding, and the like, without departing from the scope of the invention. Preferably, the base substrate 36 is adhesively bonded to the static cling substrate 12 using an adhesive 42, such as a low coatweight acrylic adhesive available from ACPO Ltd., Oak Harbor, Ohio.

As shown in FIG. 1-3, an interactive scene 44 is formed on the second side 40 of the base substrate 36 that is aesthetically compatible with one or more of the cut outs 14. For example, the scene 44 can be a picture of a road and roadside buildings over which a cut out 14 shaped as a vehicle can be overlayed for the amusement of the user. The scene 44 is preferably printed onto the base substrate 36 using ink 46, such as used to form an image on the cut outs 14. Although a base substrate 36 is preferred to facilitate assembly, the scene 44 can be formed on the second side 20 of the static cling substrate 12 without departing from the scope of the invention.

A scene protector sheet 50 laminated over the scene 44 protects the scene 44 from damage and seals the ink 46 from the environment. Preferably, the scene protector sheet 50 is formed from a static cling compatible material to which the cut outs 14 can adhere by means of static cling. Most preferably, the protector sheet is formed from a 1 mil polypropylene sheet, such as available from ACPO Ltd., Oak Harbor, Ohio, which is easily laminated over the scene 44 using an adhesive 47 or methods known in the art. The scene protector sheet 50 seals the ink 46 to avoid contaminating a food item when inserted therein.

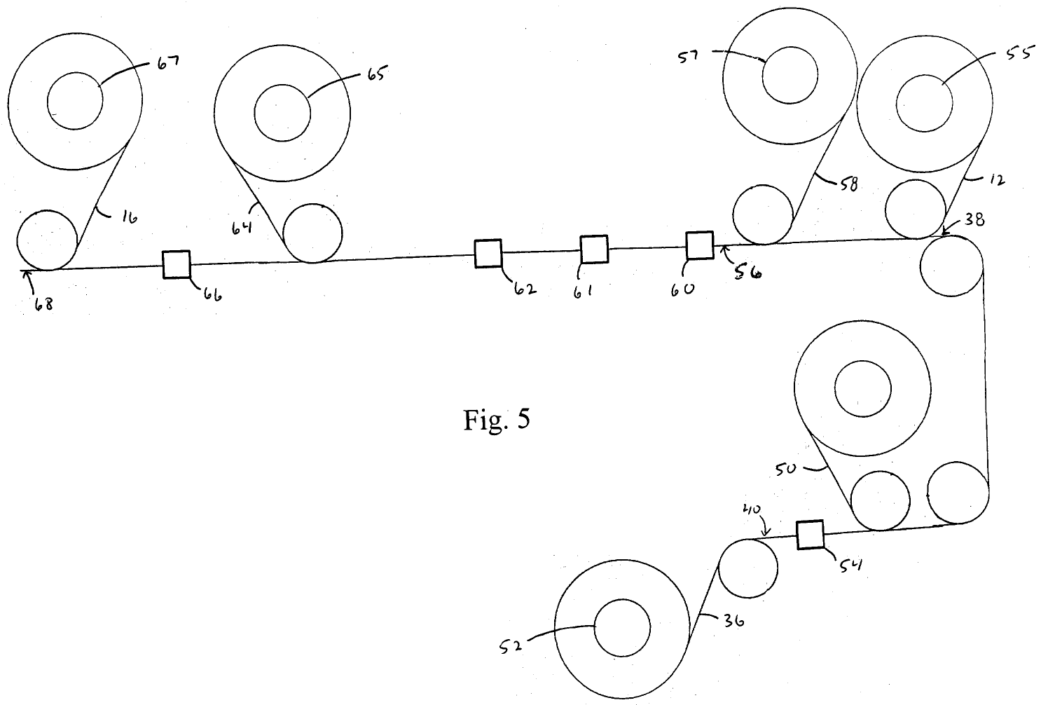

As shown in FIG. 5 with reference to FIGS. 1-4, the static cling toy assembly 10 is preferably formed using a continuous process beginning with the base substrate 36 unwinding from a spool 52. In this embodiment, the second side 40 of the base substrate 36 initially faces upwardly, and passes through a printing apparatus 54 which prints the scene 44 on the second side 40 of the base substrate 36. Although printing the scene 44 is preferred, the scene 44 can be formed using any image forming method known in the art, such as ink jet, flexographic, rotogravure, silk screening, laser etching, and the like, without departing from the scope of the invention. Once the scene 44 is formed on the base substrate 36, the scene protector sheet 50 is laminated to the base substrate 36 over the scene 44. The base substrate 36 is then turned over, such that the base substrate first side 38 faces upwardly.

The static cling substrate 12 unwinds from a spool 55, and is bonded to the upwardly facing first side 38 of the base substrate 36 using the adhesive 42. In a preferred embodiment, the base substrate 36 is provided with the adhesive 42 coated on its first side 38 and covered with a liner. In which case, the liner is removed prior to bonding the static cling substrate 12 to the base substrate first side 38.

A sheet 58 of cut out material unwinding from a spool 57 is then laid over the static cling substrate 12, and adheres to the static cling substrate 12 by means of static cling to form an intermediate assembly web 56. In a preferred embodiment, the static cling substrate 12 and cut out material sheet 58 are purchased in an adhered configuration on a single roll, such as available from Transilwrap Company, Inc. in Franklin Park, Ill., and the substrate 12 and sheet 58 are unwound simultaneously from the single roll for bonding the static cling substrate 12 to the base substrate 36.

The intermediate assembly web 56 passes through a second printing apparatus 60 which prints the image of the cut outs 14 onto the sheet 58 of cut out material. As in the scene 44, the cut out images can be formed using any method known in the art, such as ink jet, flexographic, rotogravure, silk screening, laser etching, and the like, without departing from the scope of the invention. Once the cut out images are formed, the release material 24 is applied over the cut out material, such as bypassing the intermediate web assembly 56 through a spraying apparatus 61 which sprays the release material onto the sheet 58 of cut out material. Of course, other methods known in the art for coating the cut out material with the release material can be used without departing from the scope of the invention.

Once the cut out images are printed on the sheet 58 of cut out material and covered with the release material 24, the intermediate assembly web 56 passes through a die cutting apparatus 62 which die cuts through the sheet 58 of cut out material to form the cut outs 14. Waste cut out material 64 surrounding the newly formed cut outs 14 is then stripped away exposing portions of the static cling substrate 12. The waste cut out material 64 can be wound onto a spool 65, or directed into a bin for disposal or recycling.

A second cutting apparatus 66 forms the discontinuous cut along an edge of the intermediate assembly web 56 to form the strip 32 of material forming part of the pull tab 30. The discontinuous cut defines the edge 28 of the static cling substrate and the tack points 34 joining the strip 32 to the static cling substrate 12, such that the strip 32 continues to move along with the intermediate assembly web 56 during the manufacturing process.

Once the discontinuous cut is formed, the peelable protector sheet 16 unwinds from a spool 67, and is adhesively joined to the static cling substrate 12 and adjacent strip 32 over the cut outs 14 to form a final assembly web 68. The final assembly web 68 can then pass through additional cutting assemblies (not shown) which cut the web 68 to the desired width and into independent, discrete static cling toy assemblies 10. Of course, the above steps can be performed in a different order or multiple steps can be combined without departing from the scope of the invention. For example, the cut outs can be die cut prior to applying the ink and release material without departing from the scope of the invention. In addition, the scene can be printed on the base substrate anytime during the process.

Each static cling toy assembly 10 can then be inserted into a food item as a promotional insert that is in contact with the food without the food contaminating the static cling properties of the assembly 10 or the assembly 10 contaminating the food item. Of course, if the static cling toy assembly 10 is not used as a promotional insert, one or more of the assemblies 10 can be packaged, such as in an over wrap packaging, for sale or distribution as a static cling toy.

In use, the peelable protector sheet 16 is peeled away from the static cling substrate 12 to expose the cut outs 14. Once the cut outs 14 are exposed, they can then be peeled off of the static cling substrate 12 and reapplied to the static cling substrate 12 or any surface to which the cut outs 12 adhere by means of static cling. Advantageously, in the embodiment disclosed herein, the cut outs 14 can be applied over the scene 44 formed on the base substrate second side 40 and adhere to the scene protector sheet 50 by means of static cling.

In another embodiment, disclosed in FIG. 5, a static cling toy assembly 100 has a base substrate 36 formed from a releasable adhesive assembly 70. The releaseable adhesive assembly 70 includes a liner 72 releasable from a support substrate 74 coated with a pressure sensitive adhesive. The liner 72 includes a first side 78 and a second side 80. The first side 78 of the liner 72 corresponds to the first side 38 of the base substrate 36, and is bonded to the second side 20 of the static cling substrate 12 using methods known in the art, such as described above. The second side 80 of the liner 72 is releasably bonded to a first side 82 of the support substrate 74. A second side 84 of the support substrate 74 corresponds to the second side 40 of the base substrate 36, and can include the scene 44 formed thereon which is protected by the scene protector sheet 50. The support substrate 74 can be any material known in the art, such as paper, plastic, and the like, which can be bonded to another material using a pressure sensitive adhesive or any other releasable adhesive.

Advantageously, the base substrate 36 including a releasable adhesive assembly 70 provides a self contained static cling toy assembly 68 having an interactive scene 44 which can be peeled away from the liner 72 and adhesively bonded to any surface. Once the peelable protector sheet 16 is removed, the cut outs 14 can then be peeled off of the static cling substrate 12 and adhered to the scene protector sheet 50 formed from a polypropylene or other static cling compatible material by means of static cling.

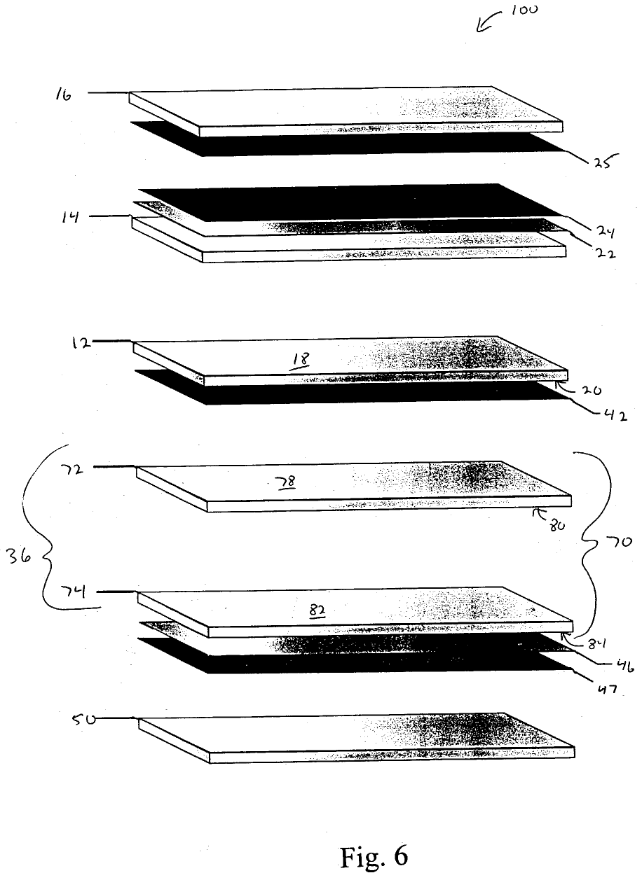

In yet another embodiment, a releasable adhesive assembly, such as disclosed in FIG. 6 can be bonded directly to the base substrate by removing the releasable adhesive assembly liner. In this embodiment, the pressure sensitive adhesive bonds the support substrate to the base substrate, or directly to the static cling substrate if a base substrate is not used, without the application of another adhesive.

While there has been shown and described what are at present considered the preferred embodiment of the invention, it will be obvious to those skilled in the art that various changes and modifications can be made therein without departing from the scope of the invention defined by the appended claims. For example, additional layers of material or coatings can be provided in addition to, or instead of, those described herein without departing from the scope of the invention. Therefore, various alternatives and embodiments are contemplated as being within the scope of the following claims particularly pointing out and distinctly claiming the subject matter regarded as the invention.

I claim:

1. A static cling toy assembly comprising:
a static cling substrate having a first side and a second side;
at least one cut out adhering to said first side of said substrate by means of static cling; and
a peelable protector sheet releasably fixed over said at least one cut out to said first side of said substrate, wherein said protector sheet encapsulates said at least one cut out and protects said at least one cut out from contamination.

2. The static cling toy assembly as in claim 1, in which said at least one cut out is formed from nylon, and said static cling substrate is formed from an oriented polyester.

3. The static cling toy assembly as in claim 1, in which a base substrate having a first side and a second side is adhesively fixed to said second side of said static cling substrate.

4. The static cling toy assembly as in claim 3, in which said base substrate is selected from a group consisting of a releasable adhesive assembly, propylene, and paper.

5. The static cling toy assembly as in claim 4, in which said releasable adhesive assembly includes a release liner releasably fixed to support substrate using a pressure sensitive adhesive.

6. The static cling toy assembly as in claim 3, in which said first side of said base substrate is adhesively fixed to said second side of said static cling substrate, and a scene is printed on said second side of said base substrate.

7. The static cling toy assembly as in claim 6, in which said scene is sealed by a sealing material.

8. The static cling toy assembly as in claim 7, in which said sealing material is a polypropylene sheet adhesively fixed over said scene.

9. The static cling toy assembly as in claim 1, including a pull tab adjacent at least one edge of said base substrate is joined to said protector sheet.

10. The static cling toy assembly as in claim 9, in which said pull tab is joined to said substrate by at least one tack point.

11. A static cling toy assembly comprising:
a static cling substrate having a first side and a second side;
at least one cut out adhering to said first side of said static cling substrate by means of static cling;
a base substrate having a first side and a second side, said first side being adhesively fixed to said second side of said static cling substrate;
a scene printed on said second side of said base substrate; and
a protector sheet overlaying said scene, wherein said at least one cutout is removable from said first side of said static cling substrate and can statically cling over said scene to said protector sheet.

12. The static cling toy assembly as in claim 11, in which said at least one cut out is formed from nylon, and said static cling substrate is formed from an oriented polyester.

13. The static cling toy assembly as in claim 11 including a peelable protector sheet releasably fixed over said at least one cut out, wherein said protector sheet encapsulates said at least one cut out and protects said at least one cut out from contamination.

14. The static cling toy assembly as in claim 11, in which said base substrate is selected from a group consisting of a releasable adhesive assembly, propylene, and paper.

15. The static cling toy assembly as in claim 14, in which said releasable adhesive assembly includes a release liner releasably fixed to a support substrate using a pressure sensitive adhesive.

16. The static cling toy assembly as in claim 13, including a pull tab adjacent at least one edge of said base substrate is joined to said protector sheet.

17. The static cling toy assembly as in claim 16, in which said pull tab is joined to said substrate by at least one tack point.

18. A method of making a static cling toy assembly, said method including:
providing a sheet of cut out material on a static cling substrate, wherein said sheet of cut out material adheres to said static cling substrate by means of static cling;
cutting at least one cut out having a predetermined shape into said cut out material forming said cut out and cut out waste material;
stripping said cut out waste material away from said static cling substrate to expose a portion of said static cling substrate; and
releasably bonding a protector sheet to said static cling substrate to cover said at least one cut out and protect said at least one cut out from contamination.

19. The method as in claim 18, in which a release material is applied over said at least one cut out prior to stripping said cut out waste material away.

20. The method as in claim 18, including forming an image of said at least one cut out on said cut out material prior to releasably bonding said protector sheet to said static cling substrate.

21. The method as in claim 18 including forming a discontinuous cut through said static cling substrate adjacent at least one edge of said static cling substrate to form a strip of material, and said protector sheet is bonded to said static cling substrate and strip of material to form a pull tab for peeling said protector sheet away from said static cling substrate.

22. The method as in claim 18, in which said static cling substrate forms part of an intermediate web assembly having a first side and a second side, wherein said cut out material adheres to said first side of said intermediate web assembly.

23. The method as in claim 22, including forming a scene on said second side of said intermediate web assembly.

24. The method as in claim 23, in which forming said scene includes applying ink to said second side of said intermediate web assembly.

25. The method as in claim 23 including bonding a protector sheet to said second side of said intermediate web assembly over said scene, wherein said at least one cut out is adhereable to said protector sheet by means of static cling.

26. The method as in claim 25, in which said static cling substrate has a first side and a second side, and said first side of said intermediate assembly corresponds to said first side of said static cling substrate, and said method includes bonding a base substrate having a first side and a second side to said second side of said static cling, wherein said first side of said base substrate is bonded to said second side of said static cling substrate, and said second side of said base substrate corresponds to said second side of said intermediate web assembly.

27. The method as in claim 26, in which said base substrate is selected from a group consisting of a releasable adhesive assembly, propylene, and paper.
